(19) United States
(12) Patent Application Publication
(10) Pub. No.: US 2009/0087258 A1
(43) Pub. Date: Apr. 2, 2009

(54) LOCKING DRIVE HUB AND METHOD OF USING THE SAME

(75) Inventor: Joseph B. McCabe, Jackson, TN (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: EMERSON ELECTRIC CO., St. Louis, MO (US)

(21) Appl. No.: 11/866,085

(22) Filed: Oct. 2, 2007

(51) Int. Cl. F16B 7/04

(52) U.S. Cl. 403/370

(57) ABSTRACT

A locking drive hub and method of use comprising a drive hub inner element having a slit and a drive hub inner element diameter; and a drive hub outer element; wherein the drive hub outer element is capable of decreasing the drive hub inner element diameter. The drive hub inner element may comprise a plurality of tap holes and/or may have a slope, preferably an inclined slope. The drive hub outer element may comprise a plurality of clearance holes and/or my have a slope, preferably a decline slope. The locking drive hub may also comprise a plurality of hardware, such as screws or bolts, and/or a plurality jack screw holes. It is envisioned that this device may preferably engage and disengage a shaft such as a shaft of a generator or motor.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### FIELD OF THE INVENTION

The invention relates to mechanical locking mechanisms, including locking mechanisms for drive hubs in generator and motor applications.

### BACKGROUND OF THE INVENTION

The prior art contains many forms of direct drive units. In these embodiments, the alternator rotor is coupled directly to the engine drive shaft.

The couplings of the prior art hot dropped on to the shaft. It is very difficult to try to disassemble this coupling.

In order to remove this type of coupling, it required that the hub be heated by typically three heat sources such as blow torches to evenly expand the hub. At the same time, a fourth person has to exert a significant pulling force using something akin to a bearing puller to disconnect these pieces. This process is inconvenient to perform.

Therefore, a need exists to offer a reliable hub locking mechanism that also is convenient to disconnect without the cumbersome methods of the prior art.

### BRIEF SUMMARY OF THE INVENTION

A taper lock hub that incorporates a mechanical lock that does not require heating for removal. In a preferred embodiment, a series of bolts can be loosened to release the locking mechanism, which will allow the hub to be removed.

A locking drive hub comprising a drive hub inner element having a slit and a drive hub inner element diameter; and a drive hub outer element; wherein the drive hub outer element is capable of decreasing the drive hub inner element diameter. The drive hub inner element may comprise a plurality of tap holes and/or may have a slope, preferably an inclined slope. The drive hub outer element may comprise a plurality of clearance holes and/or my have a slope, preferably a decline slope. The locking drive hub may also comprise a plurality of hardware, such as screws or bolts, and/or a plurality jack screw holes. It is envisioned that this device may preferably engage a shaft such as a shaft of a generator or motor.

A method of engaging a locking drive hub to a shaft, which comprises the steps of: (a) placing a drive hub inner element having a slit and a drive hub inner element diameter about the shaft; and (b) placing a drive hub outer element over the drive hub inner element; (c) compressing the drive hub inner element by moving the drive hub outer element such that the drive hub inner element diameter decreases. This method may preferably including torquing the drive hub outer element and/or axially aligning the drive hub inner element with the drive hub outer element.

A method of disengaging a locking drive hub from a shaft, which comprises the step of decompressing a drive hub inner element, wherein the inner drive hub element has a drive hub inner element diameter about the shaft, by moving a drive hub outer element such that the drive hub inner element diameter increases. This method may preferably include prying the drive hub outer element away from the drive hub inner element.

### BRIEF DESCRIPTION OF THE SEVERAL VIEWS OF THE DRAWINGS

FIG. 1 shows a cross sectional view of the prior art;

FIG. 2 shows a cross sectional view of an embodiment of a drive hub assembly; and

FIG. 3 shows an exploded perspective view of an embodiment of a locking drive hub assembly.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

One or more illustrative embodiments incorporating the invention disclosed herein are presented below. Not all features of an actual implementation are described or shown in this application for the sake of clarity. It is understood that in the development of an actual embodiment incorporating the present invention, numerous implementation-specific decisions must be made to achieve the developer's goals, such as compliance with system-related, business-related, government-related and other constraints, which vary by implementation and from time to time. While a developer's efforts might be complex and time-consuming, such efforts would be, nevertheless, a routine undertaking for those of ordinary skill in the art having benefit of this disclosure.

FIG. 1 shows a cross sectional view of the prior art. This drive hub assembly 100 is an example of a hot drop forged component. The drive hub 102 is connected to the rotor shaft 104 by means of interference fit. The drive hub 102 may or may not be keyed in prior art. The typical means of attachments requires heating the drive hub 102 to expand the inside diameter of the drive hub 102 and applying it to the shaft 104. When the drive hub 102 returns to normal temperature, the inner diameter returns of the drive hub 102 to a normal, smaller diameter which creates the interference fit.

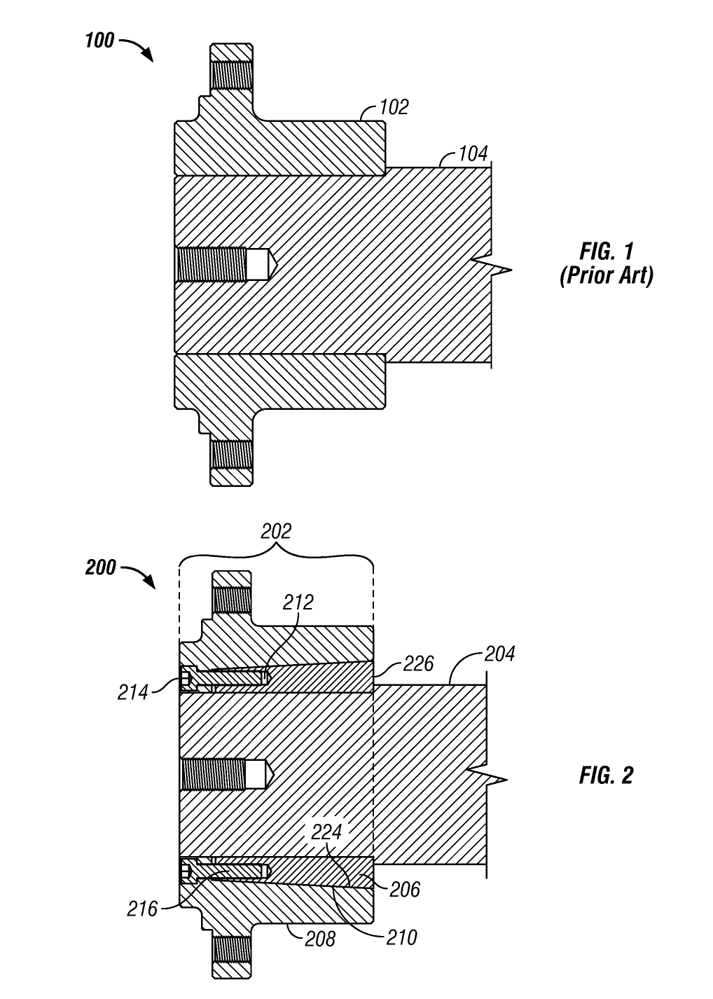

FIG. 2 shows drive hub assembly of the present invention. In contrast, the present invention the drive hub assembly 200 contains a locking drive hub 202 with a shaft 204 disposed within that is not formed by a hot drop formation. A drive hub inner element 206 is in direct contact with the shaft 204. As will be shown in subsequent drawings, a slit is formed in drive hub inner element 206 that allows the diameter drive hub inner element 206 to be decreased.

As shown, the drive hub inner element 206 has an inner element inclined slope 210 formed about the outer diameter of the drive hub inner element 206. The outer diameter of the drive hub inner element 206 has an outer diameter that increases from the end of the shaft 204 to form the inner element inclined slope 210. The drive hub inner element 206 has tap holes 212 formed therein.

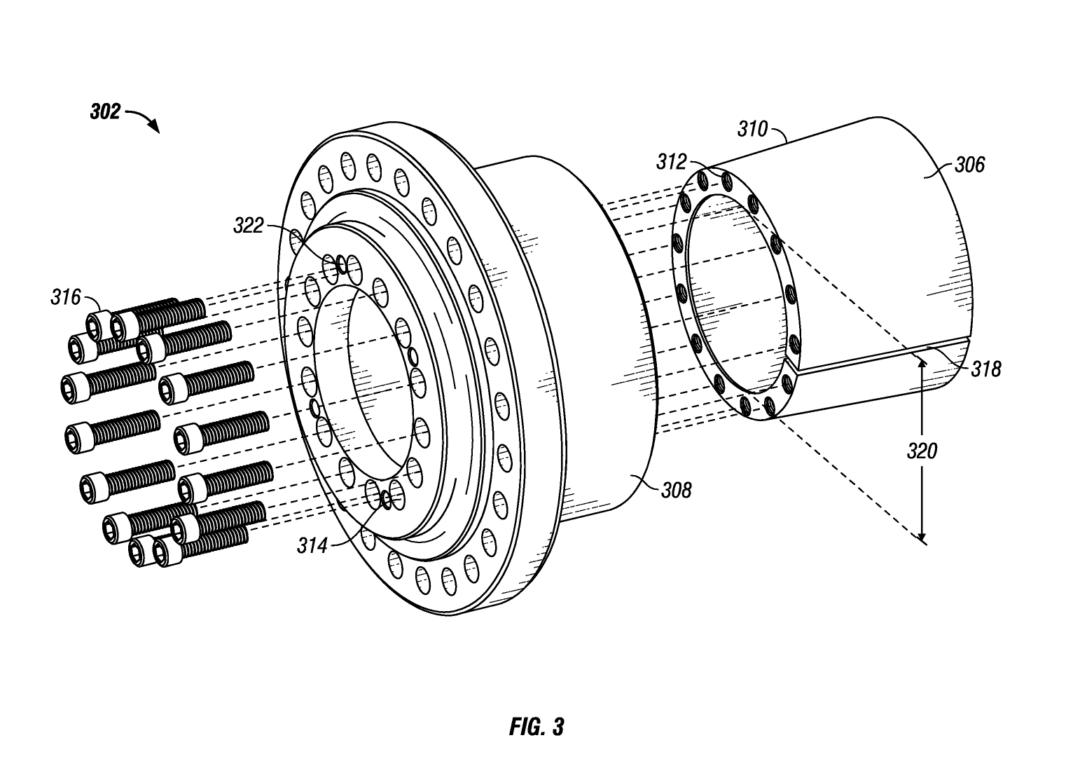

A drive hub outer element 208 surrounds the drive hub inner element 206. The drive hub outer element 208 has clearance holes 214 formed therein. As the outer drive hub outer element 208 is pulled up the inner element inclined slope 210, the drive hub inner element 206 is allowed to compress as a result of its slotted nature resulting in the locking of the locking drive hub 202 to the shaft 204. Because of the slit in the drive hub inner element 206, the diameter of the drive hub inner element 206 may decrease from its uncompressed state shown in FIG. 3.

The drive hub inner element 206 is tapped such at that hardware 216 may travel through clearance holes 214 in the drive hub outer element 208 and engages tap holes 212 in the drive hub inner element 206. The hardware 216 is preferably a screw or bolt, such as a socket head cap screw. As it is torqued, the drive hub outer element 208 travels up the inner element inclined slope 210 of the drive hub inner element 206, compressing the drive hub inner element 206, resulting in the locking of the assembly 200.

The drive hub outer element 208 has a complementary decline slope 224 that engages the inner element inclined slope 210 of drive hub inner element 206 such that at full compression of the drive hub inner element 206, the drive hub outer element 208 and drive hub inner element 206 are approximately axially aligned at the inboard side 226 in a preferred embodiment.

FIG. 3 is an exploded perspective view of locking drive hub assembly 302. A drive hub inner element 306 has a slit 318 is formed therein. This allows the inner diameter 320 of drive hub inner element 306 to be decreased.

As shown, the drive hub inner element 306 has an inner element inclined slope 310 formed about the outer diameter of the drive hub inner element 306. The drive hub inner element 306 has tap holes 312 formed therein. A drive hub outer element 308 has clearance holes 314 formed therein.

There are jack screw holes 322 used for disassembly purposes to pry the drive hub outer element 308 away from the drive hub inner element 306 to allow the drive hub inner element 306 to return to its uncompressed state. Those skilled in the art will recognize the advantage of multiple jack screw holes 322 to aid in the disassembly.

Those skilled in the art will recognize that drive hubs, drive flanges, and drive couplings are considered to be within the scope of the invention. However, this device will be of benefit as a locking mechanism for a drive hub in a variety of generator and motor applications. Those skilled in the art will recognize that any arrangement with tapers of any direction would benefit from the teachings of the invention.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intends to protect all such modifications and improvements to the full extent that such falls within the scope or range of equivalent of the following claims.

What is claimed is:

1. A locking drive hub comprising:
a drive hub inner element having a slit and a drive hub inner element diameter; and
a drive hub outer element; wherein the drive hub outer element is capable of decreasing the drive hub inner element diameter.

2. The locking drive hub of claim 1, wherein the drive hub inner element comprises a plurality of tap holes.

3. The locking drive hub of claim 1, wherein the drive hub outer element comprises a plurality of clearance holes.

4. The locking drive hub of claim 1, further comprising a plurality of hardware.

5. The locking drive hub of claim 4, wherein the hardware are screws or bolts.

6. The locking drive hub of claim 1, wherein the drive hub inner element has a slope.

7. The locking drive hub of claim 6, wherein the drive hub inner element has an inclined slope.

8. The locking drive hub of claim 1, wherein the drive hub outer element has a slope.

9. The locking drive hub of claim 8, wherein the drive hub outer element has a decline slope.

10. The locking drive hub of claim 1, further comprising a plurality jack screw holes.

11. A locking drive hub capable of engaging a shaft comprising:
a drive hub inner element having a slit and a drive hub inner element diameter; and
a drive hub outer element; wherein the drive hub outer element is capable of decreasing the drive hub inner element diameter to engage the shaft.

12. The locking drive hub of claim 11, wherein the drive hub inner element comprises a plurality of tap holes.

13. The locking drive hub of claim 11, wherein the drive hub outer element comprises a plurality of clearance holes.

14. The locking drive hub of claim 11, further comprising a plurality of hardware.

15. The locking drive hub of claim 11, wherein the drive hub inner element has a slope.

16. The locking drive hub of claim 11, wherein the drive hub outer element has a slope.

17. The locking drive hub of claim 11, further comprising a plurality jack screw holes.

18. A method of engaging a locking drive hub to a shaft, which comprises the Steps of:
(a) placing a drive hub inner element having a slit and a drive hub inner element diameter about the shaft; and
(b) placing a drive hub outer element over the drive hub inner element;
(c) compressing the drive hub inner element by moving the drive hub outer element such that the drive hub inner element diameter decreases.

19. The method of claim 18, wherein Step (c) further comprises torquing the drive hub outer element.

20. The method of claim 18, wherein Step (c) further comprises axially aligning the drive hub inner element with the drive hub outer element.

21. A method of disengaging a locking drive hub from a shaft, which comprises the Step of decompressing a drive hub inner element, wherein the inner drive hub element has a drive hub inner element diameter about the shaft, by moving a drive hub outer element such that the drive hub inner element diameter increases.

22. The method of claim 21, wherein the locking drive hub further comprises jack screw holes, wherein the Step of decompressing a drive hub inner element further comprises prying the drive hub outer element away from the drive hub inner element.
